(19) United States
(12) Patent Application Publication
(10) Pub. No.: US 2008/0086311 A1
(43) Pub. Date: Apr. 10, 2008

(54) Speech Recognition, and Related Systems

(76) Inventors: William Y. Conwell, Portland, OR (US); Joel R. Meyer, Lake Oswego, OR (US)

Correspondence Address: DIGIMARC CORPORATION, 9405 SW GEMINI DRIVE, BEAVERTON, OR, 97008, US

(21) Appl. No.: 11/697,610

(22) Filed: Apr. 6, 2007

Related U.S. Application Data
(60) Provisional application No. 60/791,480, filed on Apr. 11, 2006.

(51) Int. Cl. G10L 19/00; H04M 1/00

(52) U.S. Cl. 704/500; 455/556.2

(57) ABSTRACT

In one arrangement, information useful in understanding the content of user speech (e.g., phonemes identified by a speech recognition algorithm, data indicating the gender of the speaker, etc.) is determined at an apparatus (e.g., a cell phone), and accompanies speech data sent from that apparatus. (Steganographic encoding of the speech data can be employed to convey this information.) A receiving device can use this accompanying information to better understand the content of the speech. A great variety of other features and arrangements—some dealing with imagery rather than audio—are also detailed.

### RELATED APPLICATION DATA

This application claims priority from provisional application 60/791,480, filed Apr. 11, 2006.

### BACKGROUND

One of the last great gulfs in our automated society is the one that separates the spoken human word from computer systems.

General purpose speech recognition technology is known and is ever-improving. However, the Holy Grail in the field—an algorithm that can understand all speakers—has not yet been found, and still appears to be a long time off. As a consequence, automated systems that interact with humans—such as telephone customer service attendants (“Please speak or press your account number . . . ”) are limited in their capabilities. For example, they can reliably recognize the digits 0-9 and ‘yes’/‘no’ but not much more.

A much higher level of performance can be achieved if the speech recognition system is customized (e.g., by training) to recognize a particular user's voice. ScanSoft's Dragon Naturally Speaking software and IBM's ViaVoice software (described, e.g., in U.S. Pat. Nos. 6,629,071, 6,493,667, 6,292,779 and 6,260,013) are systems of this sort. However, such speaker-specific voice recognition technology is not applicable in general purpose applications, since there is no access to the necessary speaker-specific speech databases.

### BRIEF DESCRIPTION OF THE DRAWINGS

FIGS. 1-5 show exemplary methods and systems employing the presently-described technology.

### DETAILED DESCRIPTION

In accordance with one embodiment of the subject technology, a user speaks into a cell phone. The cell phone is equipped with speaker-specific voice recognition technology that recognizes the speech. The corresponding text data that results from such recognition process can then be steganographically encoded (e.g., by an audio watermark) into the audio transmitted by the cell phone.

When the encoded speech is encountered by an automated system, the system can simply refer to the steganographically encoded information to discern the meaning of the audio.

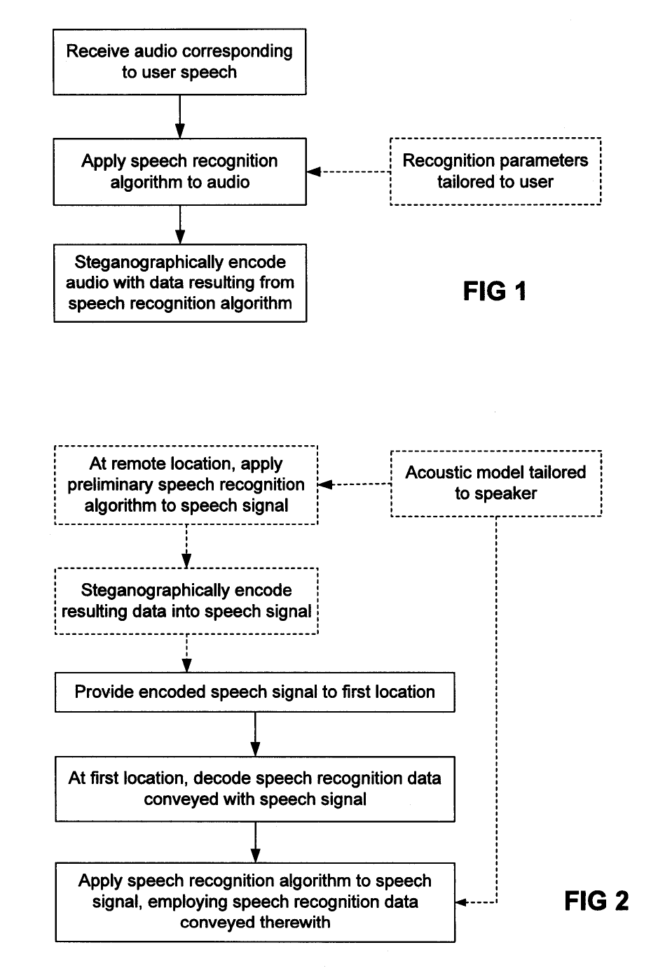

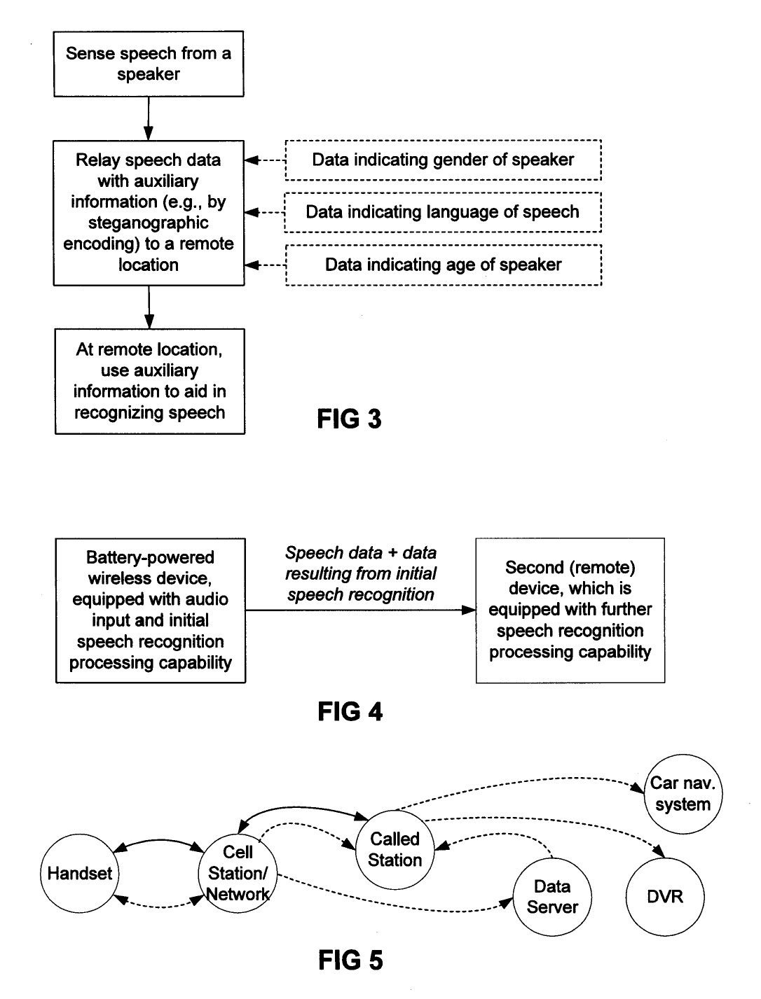

This and related arrangements are generally shown in FIGS. 1-4.

In some embodiments, the cell phone does not perform a full recognition operation on the spoken text. It may just recognize, e.g., a few phonemes, or provide other partial results. However, any processing done on the cell phone has an advantage over processing done at the receiving station, in that it is free of intervening distortion, e.g., distortion introduced by the transmission channel, audio processing circuitry, audio compression/decompression, filtering, band-limiting, etc.

Thus, even a general purpose recognition algorithm—not tailored to a particular speaker—adds value when provided on the cell phone device. (Many cell phones incorporate such a generic voice recognition capability, e.g., for hands-free dialing functionality.) The receiving device can then utilize the phonemes—or other recognition data encoded in the audio data by the cell phone—when it seeks to interpret the meaning of the audio.

An extreme example of the foregoing is to simply steganographically encode the cell phone audio with an indication of the language spoken by the cell phone owner (English, Spanish, etc.). Other such static clues might also be encoded, such as the gender of the cell phone owner, their age, their nominal voice pitch, timbre, etc. (Such information can be entered by the user, with keypad data entry or the like. Or it can simply be measured or inferred from the user's speech.) All such information is regarded as speech recognition data. Such data allows the receiving station to apply a recognition algorithm that is at least somewhat tailored to that particular class of speaker. This information can be sent in addition to partial speech recognition results, or without such partial results.

In one arrangement, a conventional desktop PC—with its expansive user interface capabilities—is used to generate the voice recognition database for a specific speaker, in a conventional manner (e.g., as used by the commercial products noted above). This data is then transferred into the memory of the cell phone and is used to recognize the speaker's voice.

Speech recognition based on such database can be made more accurate by characterizing the difference between the cell phone's acoustic channel, and that of the PC system on which the voice was originally characterized. This difference may be discerned, e.g., by having the user speak a short vocabulary of known words into the cell phone, and comparing their acoustic fingerprint as received at the cell phone (with its particular microphone placement, microphone spectral response, intervening circuitry bandpass characteristics, etc.) with that detected when the same words were spoken in the PC environment. Such difference—once characterized—can then be used to normalize the audio provided to the cell phone speech recognition engine to better correspond with the stored database data. (Or, conversely, the data in the database can be compensated to better correspond to the audio delivered through the cell phone channel leading to the recognition engine.)

The cell phone can also download necessary data from a speaker-specific speech database at a network location where it is stored. Or, if network communications speeds permit, the speaker-specific data needn't be stored in the cell phone, but can instead be accessed as needed from a data repository over a network. Such a networked database of speaker-specific speech recognition data can provide data to both the cell phone, and to the remote system—in situations where both are involved in a distributed speech recognition process.

In some arrangements, the cell phone may compile the speaker-specific speech recognition data on its own. In incremental fashion, it may monitor the user's speech uttered into the cell phone, and at the conclusion of each phone call prompt the user (e.g., using the phone's display and speaker) to identify particular words. For example, it may play-back an initial utterance recorded from the call, and inquire of the user whether it was (1) HELLO, (2) HELEN, (3) HERO, or (4) something else. The user can then press the corresponding key and, if (4), type-in the correct word. A limited number of such queries might be presented after each call. Over time, a generally accurate database may be compiled. (However, as noted earlier, any recognition clues that the phone can provide will be useful to a remote voice recognition system.)

In some embodiments, the recognition algorithm in the cell phone (e.g., running on the cell phone's general purpose processor in accordance with application software instructions, or executing on custom hardware) may operate in essentially real time. More commonly, however, there is a bit of a lag between the utterance and the corresponding recognized data. This can be redressed by delaying the audio, so that the encoded data is properly synchronized. However, delaying the audio is undesirable in some situations. In such situations the encoded information may lag the speech. In the audio HELLO JOHN, for example, ASCII text ‘hello’ may be encoded in the audio data corresponding to the word JOHN.

The speech recognition system can enforce a constant-lag, e.g., of 700 milliseconds. Even if the word is recognized in less time, its encoding in the audio is deferred to keep a constant lag throughout a transmission. The amount of this lag can be encoded in the transmission—allowing a receiving automated system to apply the clues correctly in trying to recognize the corresponding audio (assuming fully recognized ASCII text data is not encoded; just clues). In other embodiments, the lag may vary throughout the course of the speech, and the then-current lag can be periodically included with the data transmission. For example, this lag data may indicate that certain recognized text (or recognition clues) corresponds to an utterance that ended 200 milliseconds previously (or started 500 milliseconds previously, or spanned a period 500-200 milliseconds previously). By quantizing such delay representations, e.g., to the nearest 100 milliseconds, such information can be compactly represented (e.g., 5-10 bits).

The reader is presumed to be familiar with audio watermarking. Such arrangements are disclosed, e.g., in U.S. Pat. Nos. 6,614,914, 6,122,403, 6,061,793, 5,687,191, 6,507,299 and 7,024,018. In one particular arrangement, the audio is divided into successive frames, each encoded with watermark data. The watermark payload may include, e.g., recognition data (e.g., ASCII), and data indicating a lag interval, as well as other data. (Error correction data is also desirably included.)

While the present assignee prefers to convey such auxiliary information in the audio data itself (through an audio watermarking channel), other approaches can be used. For example, this auxiliary data can be sent with non-speech administrative data conveyed in the cell phone's packet transmissions. Other “out-of-band” transmission protocols can likewise be used (e.g., in file headers, various layers in known communications stacks, etc.). Thus, it should be understood that embodiments which refer to steganographic/watermark encoding of information, can likewise be practiced using non-steganographic approaches.

It will be recognized that such technology is not limited to use with cell phones. Any audio processing appliance can similarly apply a recognition algorithm to audio, and transmit information gleaned thereby (or any otherwise helpful information such as language or gender) with the audio to facilitate later automated processing. Nor is the disclosed technology limited to use in devices having a microphone; it is equally applicable to processing of stored or streaming audio data.

Technology like that detailed above offers significant advantages, not just in automated customer-service systems, but in all manner of computer technology. To name but one example, if a search engine such as Google encounters an audio file on the web, it can check to see if voice recognition data is encoded therein. If full text data is found, the file can be indexed by reference thereto. If voice recognition clues are included, the search engine processor can perform a recognition procedure on the file—using the embedded clues. Again, the resulting data can be used to augment the web index. Another application is cell-phone querying of Google—speaking the terms for which a search is desired. The Google processor can discern the search terms from the encoded audio (without applying any speech recognition algorithm, if the encoding includes earlier-recognized text), conduct a search, and voice the results back to the user over the cell phone channel (or deliver the results otherwise, e.g., by SMS messaging).

A great number of variations and modifications to the foregoing can be adopted.

One is to employ contextual information. One type of contextual information is geographic location, such as is available from the GPS systems included in contemporary cell phones. A user could thus speak the query “How do I get to La Guardia?” and a responding system (e.g., an automated web service such as Google) could know that the user's current position is in lower Manhattan and would provide appropriate instructions in response. Another query might be “What Indian restaurants are between me and Heathrow?” A web service that provides restaurant selection information can use the conveyed GPS information to provide an appropriate restaurant selections. (Such responses can be annunciated back to the caller, sent by SMS text messaging or email, or otherwise communicated. In some arrangements, the response of the remote system may be utilized by another system—such as turn-by-turn navigation instructions leading the caller to a desired destination. In appropriate circumstances, the response information can be addressed directly to such other system for its use (e.g., communicated digitally over wired or wireless networks)—without requiring the caller to serve as an intermediary between systems.)

In the just-noted example, the contextual information (e.g., GPS data) would normally be conveyed from the cell phone. However, in other arrangements contextual information may be provided from other sources. For example, preferences for a cell phone user may be stored at a remote server (e.g., such as may be maintained by Yahoo, MSN, Google, Verisign, Verizon, Cingular, a bank, or other such entity—with known privacy safeguards, like passwords, biometric access controls, encryption, digital signatures, etc.). A user may speak an instruction to his cell phone, such as “Buy tickets for tonight's Knicks game and charge my VISA card. Send the tickets to my home email account.” Or “Book me the hotel at Kennedy.” The receiving apparatus can identify the caller, e.g., by reference to the caller's phone number. (The technology for doing so is well established. In the U.S., an intelligent telephony network service transmits the caller's telephone number while the call is being set up, or during the ringing signal. The calling party name may be conveyed in similar manner, or may be obtained by an SS7 TCAP query from an appropriate names database.) By reference to such an identifier, the receiving apparatus can query a database at the remote server for information relating to the caller, including his VISA card number, his home email account address, his hotel preferences and frequent-lodger numbers, and even his seating preference for basketball games.

In other arrangements, preference information can be stored locally on the user device (e.g., cell phone, PDA, etc.). Or combinations of locally-stored and remotely-stored data can be employed.

Other arrangements that use contextual information to help guide system responses are given in U.S. Pat. Nos. 6,505,160, 6,411,725, 6,965,682, in patent publications 20020033844 and 20040128514, and in application Ser. No. 11/614,921.

A system that employs GPS data to aid in speech recognition and cell phone functionality is shown in patent publication 20050261904.

For better speech recognition, the remote system may provide the handset with information that may assist with recognition. For example, if the remote system poses a question that can be answered using a limited vocabulary (e.g. Yes/No; or digits 0-9; or street names within the geographical area in which the user is located; etc.), information about this limited universe of acceptable words can be sent to the handset. The voice recognition algorithm in the handset then has an easier task of matching the user's speech to this narrowed universe of vocabulary. Such information can be provided from the remote system to the handset via data layers supported by the network that links the remote system and the handset. Or, steganographic encoding or other known communication techniques can be employed.

In similar fashion, other information that can aid with recognition may be provided to the user terminal from a remote system. For example, in some circumstances the remote system may have knowledge of the language expected to be used, or of the ambient acoustical environment from which the user is calling. This information can be communicated to the handset to aid in its processing of the speech information. (The acoustic environment may also be characterized at the handset—e.g., by performing an FFT on the ambient noise sensed during pauses in the caller's speech. This is another type of auxiliary information that can be relayed to the remote system to aid it in better recognizing the desired user speech, such as by applying an audio filter tailored to attenuate the sensed noise.)

In some embodiments, something more than partial speech recognition can be performed at the user terminal (e.g., wireless device); indeed, full speech recognition may be performed. In such cases, transmission of speech data to the responding system may be dispensed with. Instead, the wireless device can simply transmit the recognized data, e.g., in ASCII, SMS text messaging, DTMF tones, CDMA or GSM data packets, or other format. In an exemplary case, such as “Speak your credit card number” the handset may perform full recognition, and the data sent from the handset may comprise simply the credit card number (1234-5678-9012-3456); the voice channel may be suppressed.

Some devices may dynamically switch between two or more modes, depending on the results of speech recognition. A handset that is highly confident that it has accurately recognized an interval of speech (e.g., by a confidence metric exceeding, say, 99%) may not transmit the audio information, but instead just transmit the recognized data. If, in a next interval, the confidence falls below the threshold, the handset can send the audio accompanied by speech recognition data—allowing the receiving station to perform further analysis (e.g., recognition) of the audio.

The destinations to which data are sent can change with the mode. In the former case, for example, the recognized text data can be to the SMS interface of Google (text message to GOOGL), or to another appropriate data interface. In the latter case, the audio (with accompanying speech recognition data) can be sent to a voice interface. The cell phone processor can dynamically switch the data destination depending on the type of data being sent.

When using a telephony device to issue verbal search instructions (e.g., to online search services), it can be desirable that the search instructions follow a prescribed format, or grammar. The user may be trained in some respects (just as users of tablet computers and PDAs are sometimes trained to write with prescribed symbologies that aid in handwriting recognition, such as Palm's Graffiti). However, it is desirable to allow users some latitude in the manner they present queries. The cell phone processor can perform some processing to this end. For example, if it recognizes the speech “Search CNN dot corn for hostages in Iran,” it may apply stored rules to adapt this text to a more familiar Google search query, e.g., “site:cnn.com hostages iran.” This later query, rather than the literal recognition of the spoken speech, can be transmitted from the phone to Google, and the results then presented to the user on the cell phone's screen or otherwise. Similarly, the speech “What is the stock price of IBM?” can be converted by the cell phone processor—in accordance with stored rules, to the Google query “stock:ibm.” The speech “What is the definition of mien M I E N?” can be converted to the Google query “define:mien.” The speech “What HD-DVD players cost less than $400” can be converted to the Google query “HD-DVD player $0 . . . 400.”

The phone—based on its recognition of the spoken speech—may route queries to different search services. If a user speaks the text “Dial Peter Azimov,” the phone may recognize same as a request for a telephone number (and dialing of same). Based on stored programming or preferences, the phone may route requests for phone numbers to, e.g., Yahoo (instead of Google). It can then dispatch a corresponding search query to Yahoo—supplemented by GPS information if it infers, as in the example given, that a local number is probably intended. (If the instruction were “Dial Peter Azimov in Phoenix,” the search query could include Phoenix as a parameter—inferred to be a location from the term “in.”)

While phone communication is typically regarded as involving two stations, embodiments of the present technology can involve more than two stations; sometimes it is desirable for different information from the user terminal to go to different locations. FIG. 5 shows one such arrangement, in which voice information is shown in solid lines, and auxiliary data is shown in dashed lines. Both may be exchanged between a handset and a cell station/network. But the cell station/network, or other intervening system, may separate the two (e.g., decoding and removing watermarked auxiliary data from the speech data, or splitting-off out-of-band auxiliary data), and send the auxiliary data to a data server, and send the audio data to the called station. The data server may provide information back to the cell station and/or to the called station. (While the arrows in FIG. 5 show exemplary directions of information flow, in other arrangements other flows can be employed. For example, the called station may transmit auxiliary data back to the cell station/network—rather than just receiving such information from it. Indeed, in some arrangements, all of the data flows can be bidirectional. Moreover, data can be exchanged between systems in manners different than those illustrated. For example, instruction data may be provided to the DVR from the depicted data server, rather than from the called station.)

As noted, still further stations (devices/systems) can be involved. The navigation system noted earlier is one of myriad stations that may make use of information provided by a remote system in response to the user's speech. Another is a digital video recorder (DVR), of the type popularized by TiVo. (A user may call TiVo, Yahoo, or another service provider and audibly instruct “Record American Idol tonight.” After speech recognition as detailed above has been performed, the remote system can issue appropriate recording instructions to the user's networked DVR.) Other home appliances (including media players such as iPods and Zunes) may similarly be provided programming—or content—data directly from a remote location as a consequence of spoken speech. The further stations can also comprise other computers owned by the caller, such as at the office or at home. Computers owned by third parties, e.g., family members or commercial enterprises, may also serve as such further stations. Functionality on the user's wireless device might also be responsive to such instructions (e.g., in the “Dial Peter Azimov” example given above—the phone number data obtained by the search service can be routed to the handset processor, and used to place an outgoing telephone call).

Systems for remotely programming home video devices are detailed in patent publications 20020144282, 20040259537 and 20060062544.

Cell phones that recognize speech and perform related functions are described in U.S. Pat. No. 7,072,684 and publications 20050159957 and 20030139150. Mobile phones with watermarking capabilities are detailed in U.S. Pat. Nos. 6,947,571 and 6,064,737.

As noted, one advantage of certain embodiments is that performing a recognition operation at the handset allows processing before introduction of various channel, device, and other noise/distortion factors that can impair later recognition. However, these same factors can also distort any steganographically encoded watermark signal conveyed with the audio information. To mitigate such distortion, the watermark signal may be temporally and/or spectrally shaped to counteract expected distortion. By pre-emphasizing watermark components that are expected to be most severely degraded before reaching the detector, more reliable watermark detection can be achieved.

In certain of the foregoing embodiments, speech recognition is performed in a distributed fashion—partially on a handset, and partially on a system to which data from the handset is relayed. In similar fashion other computational operations can be distributed in this manner. One is deriving content “fingerprints” or “signatures” by which recorded music and other audio/image/video content can be recognized.

Such “fingerprint” technology generally seeks to generate a “robust hash” of content (e.g., distilling a digital file of the content down to perceptually relevant features). This hash can later be compared against a database of reference fingerprints computed from known pieces of content, to identify a “best” match. Such technology is detailed, e.g., in Haitsma, et al, “A Highly Robust Audio Fingerprinting System,” Proc. Intl Conf on Music Information Retrieval, 2002; Cano et al, “A Review of Audio Fingerprinting,” Journal of VLSI Signal Processing, 41, 271, 272, 2005; Kalker et al, “Robust Identification of Audio Using Watermarking and Fingerprinting,” in Multimedia Security Handbook, CRC Press, 2005, and in patent documents WO02/065782, US20060075237, US20050259819, and US20050141707.

One interesting example of such technology is in facial recognition—matching an unknown face to a reference database of facial images. Again, a facial image is distilled down to a characteristic set of features, and a match is sought between an unknown feature set, and feature sets corresponding to reference images. (The feature set may comprise eigenvectors or shape primitives.) Patent documents particularly concerned with such technology include US20020031253, US20060020630, U.S. Pat. No. 6,292,575, U.S. Pat. No. 6,301,370, U.S. Pat. No. 6,430,306, U.S. Pat. No. 6,466,695, and U.S. Pat. No. 6,563,950.

As in the speech recognition case detailed above, various distortion and corruption mechanisms can be avoided if at least some of the fingerprint determination is performed at the handset—before the image information is subjected to compression, band-limiting, etc. Indeed, in certain cell phones it is possible to process raw Bayer-pattern image data from the CCD or CMOS image sensor—before it is processed into RGB form.

Performing at least some of the image processing on the handset allows other optimizations to be applied. For example, pixel data from several cell-phone-captured video frames of image information can be combined to yield higher-resolution, higher-quality image data, as detailed in patent publication US20030002707 and in pending application Ser. No. 09/563,663, filed May 2, 2000. As in the speech recognition cases detailed above, the entire fingerprint calculation operation can be performed on the handset, or a partial operation can be performed—with the results conveyed with the (image) data sent to a remote processor.

The various implementations and variations detailed earlier in connection with speech recognition can be applied likewise to embodiments that perform fingerprint calculation, etc.

While reference has frequently been made to a “handset” as the originating device, this is exemplary only. As noted, a great variety of different apparatus may be used.

To provide a comprehensive specification without unduly lengthening this specification, applicants incorporate by reference the documents referenced herein. (Although noted above in connection with specified teachings, these references are incorporated in their entireties, including for other teachings.) Teachings from such documents can be employed in conjunction with the presently-described technology, and aspects of the presently-described technology can be incorporated into the methods and systems described in those documents.

In view of the wide variety of embodiments to which the principles and features discussed above can be applied, it should be apparent that the detailed arrangements are illustrative only and should not be taken as limiting the scope of our technology.

1. A method comprising the acts:
receiving audio corresponding to a user's speech;
obtaining speech recognition data associated with said speech;
generating digital speech data corresponding to said received audio; and
transmitting the digital speech data accompanied by the speech recognition data.

2. The method of claim 1 wherein said obtaining comprises applying a speech recognition algorithm to said received audio.

3. The method of claim 2 in which the speech recognition algorithm employs recognition parameters tailored to the user.

4. The method of claim 1 wherein said obtaining comprises obtaining data indicating a language of said speech.

5. The method of claim 1 wherein said obtaining comprises obtaining data indicating a gender of said user.

6. The method of claim 1 wherein said transmitting includes steganographically encoding said digital speech data with said speech recognition data.

7. The method of claim 1, performed by a wireless communications device.

8. The method of claim 1 wherein said transmitting further includes transmitting context information with said digital speech data and said speech recognition data.

9. A method performed at a first location, using a speech signal provided from a remote location, comprising the acts:
obtaining speech recognition data conveyed with the speech signal; and
applying a speech recognition algorithm to said speech signal, employing the speech recognition data conveyed therewith.

10. The method of claim 9, wherein said obtaining comprises decoding speech recognition data steganographically encoded in said speech signal.

11. The method of claim 9 that further includes, at the remote location and prior to the provision of said speech signal to said first location, applying a preliminary speech recognition algorithm to said speech signal, and conveying speech recognition data resulting therefrom with said speech signal.

12. The method of claim 11 in which said conveying comprises steganographically encoding said speech recognition data into said speech signal.

13. The method of claim 11 in which said preliminary speech recognition algorithm employs a model especially tailored to a speaker of said speech.

14. The method of claim 9 that further comprises transmitting to a web service a result of said speech recognition algorithm, together with context information.

15. The method of claim 14 that further includes receiving at a user device certain information responsive to said transmission to the web service, and dependent on said context information.

16. In a telecommunications method that includes sensing speech from a speaker, and relaying speech data corresponding thereto to a remote location, an improvement comprising conveying auxiliary information with said speech data, said auxiliary information comprising at least one of the following: data indicating a language of said speech, data indicating an age of said speaker, or data indicating a gender of said speaker.

17. The method of claim 16 in which said conveying comprises steganographically encoding said speech data to convey said auxiliary information.

18. A method comprising:
at a first, battery-powered, wireless device, performing an initial recognition operation on received audio or image content;
conveying a representation of said content, together with data resulting from said initial recognition operation, from said first device to a second, remotely located, device; and
at said second device, performing a further recognition operation on said representation of content, said further operation making use of data resulting from said initial operation.

19. The method of claim 18, performed on image content.

20. A mobile handset including a microphone and a speech recognition system, characterized in that a processor thereof changes the handset between different modes of operation depending on assessment of speech recognition accuracy.

21. A method using a handheld wireless communications device that includes a camera system which captures raw image data, converts same to RGB data, and compresses the RGB data, the method further including performing at least a partial fingerprint determination operation on the raw image data prior to said conversion-to-RGB and prior to said compression, and sending resultant fingerprint information from said device to a remote system.

22. The method of claim 21 that further comprises performing a further fingerprint determination operation on the sent information at said remote system.

23. The method of claim 21 that further comprises capturing plural frames of image information using said sensor, and combining raw image data from said frames to yield higher quality data prior to performing said fingerprint determination operation on the raw image-data.

24. A method of fingerprint determination comprising:
at a wireless communications device, capturing audio;
performing a partial fingerprint determination on data corresponding to said captured audio;
transmitting results from said partial fingerprint determination to a remote system; and
performing a further fingerprint determination on said remote system.

25. A method comprising:
capturing an image including a face using a camera system of a handheld wireless communications device;
performing a partial signature calculation characterizing the face in said image, using a processor in said handheld wireless communications device;
transmitting data resulting from said partial signature calculation to a remote system;
performing a further signature calculation on the remote system; and
using resultant signature data to seek a match between said face and a reference database of facial image data.
